(19) United States
(12) Patent Application Publication
(10) Pub. No.: US 2004/0075909 A1
(43) Pub. Date: Apr. 22, 2004

(54) Fingerprint resistant anti-reflection coatings for plastic substrates

(76) Inventor: Jeffrey Hunt, Thousand Oaks, CA (US)

Correspondence Address: HARNESS, DICKEY & PIERCE, P.L.C., P.O. BOX 828, BLOOMFIELD HILLS, MI, 48303, US

(21) Appl. No.: 10/723,019

(22) Filed: Nov. 26, 2003

Related U.S. Application Data
(62) Division of application No. 10/104,681, filed on Mar. 22, 2002.

(51) Int. Cl. G02B 1/10

(52) U.S. Cl. 359/586

(57) ABSTRACT

A method of forming a fingerprint-resistant anti-reflection coating for plastic substrates that includes an upper thin film layer to be exposed to an ambient environment. The upper layer has an optical path length of about a quarter wave at a pre-selected design wavelength. A lower thin film layer interfaces a plastic substrate. The lower layer has an index of refraction greater than an index of refraction of the upper layer. The lower layer has an optical path length of about a half wave at the pre-selected design wavelength. The reflectance of light from the fingerprint-resistant two-layer anti-reflection coating when applied to plastic substrates is substantially the same in oil and the ambient environment.

CROSS-REFERENCE TO RELATED APPLICATIONS

This application is a divisional of U.S. patent application Ser. No. 10/104,681 filed on Mar. 22, 2002. The disclosure of which is incorporated herein by reference.

### FIELD OF THE INVENTION

The present invention relates to anti-reflection coatings and more particularly to a two-layer fingerprint-resistant anti-reflection coating for plastic substrates.

### BACKGROUND OF THE INVENTION

TV screens, contrast enhancement filters, eyeglasses, sunglasses and instrument or touch-screen panels are routinely coated with relatively inexpensive thin films to reduce glare, shadows, “ghost images”, etc., caused by visible light reflecting from the surface of the glass or plastic substrates. These thin film “anti-reflection coatings”, while reducing reflectance, simultaneously serve to enhance the visible contrast of the desired images projected through the substrate.

Often these anti-reflection coatings consist of a single layer of magnesium fluoride, one-quarter wavelength in optical optical path length. Up until 1965, this was the primary anti-reflection coating used. Some two-layer coatings were used but it was found that they were very selective. All of such two-layer coatings had a similar limitation in that the range of substantially zero reflectance was very small and went up very steeply on opposite sides of the visible spectrum. One such two-layer coating provided the well-known V-shaped reflectance curve, whereas other two-layer coatings provided a W-shaped reflectance curve. Thus, although it was possible to obtain a narrow range of better reflectance with certain two-layer coatings, it was impossible to obtain a substantial increase in overall efficiency of such coatings in comparison to a conventional one-layer coating such as magnesium fluoride (MgF₂). In 1965 Alfred J. Thelen disclosed a substantially efficient three-layer coating in U.S. Pat. No. 3,185,020. However, due to the expense of coating three or more layers, the one layer MgF₂ coating has remained the predominant anti-reflection coating for most normal uses, while the two-layer coatings have been largely abandoned altogether.

Unfortunately, the enhanced contrast, which stems generally from single and multi-layer anti-reflection coatings also enhances the visibility of foreign marks or substances which may inadvertently occur on the coated substrates, particularly oil from fingerprints. For most purposes, fingerprints can be removed when routinely cleaning or dusting the surface in question. However, for some applications, such as eyeglasses, fingers so routinely come into contact with the substrate, that keeping them free of the image distortion caused by fingerprints is difficult over an extended period.

Generally, as discussed above, the predominant anti-reflection coatings for most common uses are single layer quarter wave MgF₂, while two-layer coatings have been practically abandoned. MgF₂ is most common as the single-layer for several reasons; e.g., it is a low cost, durable and relatively good low index material for anti-reflection single layer coatings on glass. A quarter wave optical path length is employed because this optical path length is well known to minimize reflectance of coated surfaces.

In 1998, Ferrante and Ott, in U.S. Pat. No. 5,847,876, disclosed that a two-layer coating could be used to obtain an anti-reflection coating that extended across most of the visible spectrum. This patent incorporated, as one of its film materials, MgFl₂. However, MgFl₂ can only be applied to substrates via deposition techniques that require elevating the substrate temperature. Not all substrates can be subjected to high temperatures associated with deposition. In particular, plastics will usually be damaged, deformed or cracked by cycling to high temperatures.

The prior art also includes the following examples of multi-layer anti-reflection coatings. However, they would serve to enhance rather than inhibit fingerprint images and/or would also not be applicable for use with plastics.

U.S. Pat. No. 3,604,784 discloses anti-reflection (AR) coatings having three or more layers. The coatings generally have sufficient anti-reflection effect only on expensive glass compositions having refractive indices of 1.68 to 1.88. The first layer, adjacent to air, is a quarter wave optical path length MgF₂ (n=1.38) at a design wavelength approximately in the center of the visual spectrum. The second layer is a mixture of oxides of titanium and Al₂O₃ (n=2.00) having a half wave optical path length. The third layer, adjacent to the glass, is Al₂O₃ or MgO (n=1.60-1.72) with an optical path length of a half wavelength.

U.S. Pat. No. 3,781,090 discloses a variety of four layer AR coatings effective for all conventional glass substrates. The layers, in sequence from the air side to the glass substrate side, are constructed as follows: first layer having low index of refraction (n=1.35 to 1.62); the second a high index (n=2.00 to 2.30): the third a medium index (n=1.56-1.72); the final fourth layer a low index (n=1.35-1.62).

U.S. Pat. No. 3,738,732 discloses a quasi-symmetrical three-layer coating of a desired equivalent refractive index N having a wide dispersion effect in regions adjacent to the visible region. The layers, in sequence from air to the glass substrate, are, for example, the first layer being a quarter wave optical path length MgF₂, the second layer being a half wave optical path length TiO₂, and the third being a half wave optical path length Al₂O₃ The patent shows, in the vector method, the reflectivity at the wavelength 400 microns of a double-layer (MgF2/Al₂O₃) over glass (n=1.52). The spectral transmittance will not satisfy the condition of reflectivity less than 0.3 percent to wavelengths of 4000 Å, 6000 Å, and 7000 Å (central wavelength is presumed to be 5000 Å). Such prior art coatings composed of MgF₂/Al₂O₃ would have, in fact, enhanced fingerprint images because reflectance in oil differs from reflectance in air. In the case of glass having a high refractive index, the double-layer coating having a half wave optical path length Al₂O₃ under a quarter wave optical path length MgF₂, attains the equivalent effect as that of the MgF₂ single-layer coating relative to a central wavelength, so that the reflectivity at light wavelengths other than the central wavelength may be reduced; but it was not satisfactory in view of the spectral characteristics in the visible region. FIG. 2 of the patent shows its W-shaped reflectivity curve. This is the same problem identified in US. Pat. No. 3,185,020.

U.S. Pat. No. 4,196,246 discloses anti-reflection coatings for synthetic resin substrates having a first layer SiO₂ deposited on the resin base, a second layer Al₂O₃ deposited on the first layer and a third layer SiO₂ or MgF₂ deposited on the second layer. The first is 1 to 5 microns thick while the second is a quarter wave optical path length and the third is a quarter wave optical path length.

U.S. Pat. No. 4,264,133 discloses a two or three layer coating requiring replacement of a half wave optical path length layer with a composite layer characterized by a higher equivalent inhomogeneity than the inhomogeneity of the half wave layer.

U.S. Pat. No. 4,333,983 discloses a three-layer coating having a flexible polymer first layer such as polyethylene terephthalate, commonly sold under the trademark Mylar, coated with an Al₂O₃ having an optical path length of at least 170 nanometers (half wave) at a design wavelength of 560 nanometers, with a final layer over the Al₂O₃ of, for example, MgF₂ to a optical path length of quarter wave at a design wave length of 560 nanometers.

U.S. Pat. No. 4,387,960 discloses a multi-layer anti-reflection coating having four layers defined by various refractive indices and physical thicknesses and a pre-selected design wavelength. The optical path lengths vary from one-quarter to three-quarter wave and the indices of refraction vary from 1.35 to 2.30.

U.S. Pat. No. 4,436,363 discloses a broadband anti-reflection multi-layer coating for infrared transmissive materials, which includes a first layer of zinc-selenite or zinc-sulfide.

U.S. Pat. No. 4,798,994 discloses an anti-reflection coating which comprises at least a three-layer interference filter having high refractive index materials, such as niobium oxide, and low-refractive index materials, such as silicon dioxide.

U.S. Pat. No. 4,804,883 discloses a special anti-refraction coating for cathode-ray tubes. The coating discloses a quarter wave optical path length Al₂O₃ (alumina) layer deposited on the glass substrate, a second layer being a half wave optical path length of TaO₅ (tantalum oxide) with index of refraction of 2.1, and a third layer coated thereover of one quarter wave optical path length MgF₂ (magnesium fluoride) having an index of refraction of 1.38.

U.S. Pat. No. 5,051,652 discloses a panel with an anti-reflection multi-layer film thereon which comprises a glass substrate, coated with an electricity collector for leading static electricity, a magnesium fluoride layer, a layer of zirconium oxide mixed with titanium dioxide, and a final top coating of magnesium fluoride.

U.S. Pat. No. 5,243,255 discloses a cathode-ray tube having a light transmittance of at least fifty percent and a reflectivity reduction film formed on the external surface of the tube's face plate. The reflectivity reduction film is a low refraction index layer formed by using a coating liquid obtained by a dispensing and mixing magnesium fluoride superfine particles to a base coating of an alcohol solution containing a silicon alkoxide.

Other anti-reflection coatings for cathode-ray tubes are disclosed in U.S. Pat. Nos. 5,281,893 and 5,446,339.

As noted above, U.S. Pat. No. 5,847,876 discloses a two-layer film having anti-reflective properties when applied to glass. Additionally, the patent discusses how the film's anti-reflective properties make it fingerprint resistant. The fingerprint resistant film includes an Al₂O₃ lower layer and a MgFl₂ upper layer. The film is applied to components where the substrate to be coated is made of glass.

None of these patents disclose an effective fingerprint resistant coating that can be used on plastic substrates.

### SUMMARY OF THE INVENTION

The present invention according to various embodiments may be able to provide a method for making plastic substrates fingerprint resistant.

According to various embodiments the present invention may be able to provide a novel anti-reflection coating greatly reducing reflectance over a wide band of wavelengths, yet by employing a two layer, anti-reflection coating which inhibits images of fingerprints from forming when touched by human hands.

According to various embodiments the present invention may be able to provide a coating that may be applied without heating the substrate that is to receive the coating.

In a broad aspect the present invention is a fingerprint-resistant anti-reflection coating for plastic substrates. It includes an upper thin film layer to be exposed to an ambient environment. The upper layer has an optical path length equal to a quarter wave at a pre-selected design wavelength in the range of about 450 to 550 nanometers. A lower thin film layer interfaces a plastic substrate. The lower layer has an index of refraction greater than an index of refraction of the upper layer. The index of refraction of the lower layer is at least 0.5 higher than the index of refraction of said upper layer and has an optical path length equal to a half wave at the pre-selected design wavelength in the range of about 450 to 550 nanometers. The reflectance of light from the fingerprint-resistant two-layer anti-reflection coating when applied to plastic substrates is essentially the same in oil and the ambient environment.

The upper layer is preferably formed of Al₂O₃, or SiO₂,. The lower layer is preferably formed of TiO₂. Both the upper and lower layers can be formed by ion beam deposition and can thus be applied on plastic substrates. The present invention may be useful for application with eyeglasses.

Other objects, advantages, and novel features will become apparent from the following detailed description of the invention when considered in conjunction with the accompanying drawings.

### BRIEF DESCRIPTION OF THE DRAWINGS

The present invention will become more fully understood from the detailed description and the accompanying drawings, wherein:

FIG. 1 is a schematic cross-sectional view of an anti-reflection coating of the present invention;

FIG. 2 is another schematic cross-sectional view highlighting the representative indices of refraction of the components of the present invention; and

FIG. 3 is a reflectivity graph showing reflectivity, R, as a function of wavelength for the present invention, thus showing the anti-reflectivity behavior of the present invention.

### DETAILED DESCRIPTION OF THE PREFERRED EMBODIMENTS

The discovery that equal and effective reflectance in oil and in air could be possible over a broad spectrum by employing a two-layer anti-reflection coating, resulting in the inhibition of fingerprint images on plastic substrates, is unexpected. Based upon prior state of the art teachings, the two-layer coating necessary to substantially reduce reflectance in oil and air could only be applied to substrates that can be cycled to high temperatures during deposition.

Anti-reflection coatings are customarily designed to operate at a very specific substrate refractive index, incident light wavelength and external index. A coating designed for one set of operating conditions is not expected to be useful at all under substantially different conditions. Anti-reflectance in air (index=1.0) and in oil (index=1.5-1.6) is such a large index shift that, in general, coatings designed for use in air perform poorly in oil and vice versa. Fingerprint resistance is herein surprisingly achieved by a narrow range of specific design indices that result in performance nearly the same in air and oil (a much more stringent operating requirement). This unexpectedly simple and environmentally stable invention uses readily available coating materials.

In accordance with this invention, it has been surprisingly discovered that preferably a layer of titanium oxide formed on a plastic substrate to an optical path length equal to a half wave at a pre-selected design wavelength in the range of 450 to 550 nanometers, preferably about 500 nanometers, provides a fingerprint resistant optical coating when, deposited thereon an upper layer. The upper layer has a quarter wavelength optical path length of preferably silicon oxide (with a refractive index of 1.48) or aluminum oxide (with a refractive index of 1.85) at the pre-selected design wavelength in the range of 450-550 nanometers, preferably about 500 nanometers.

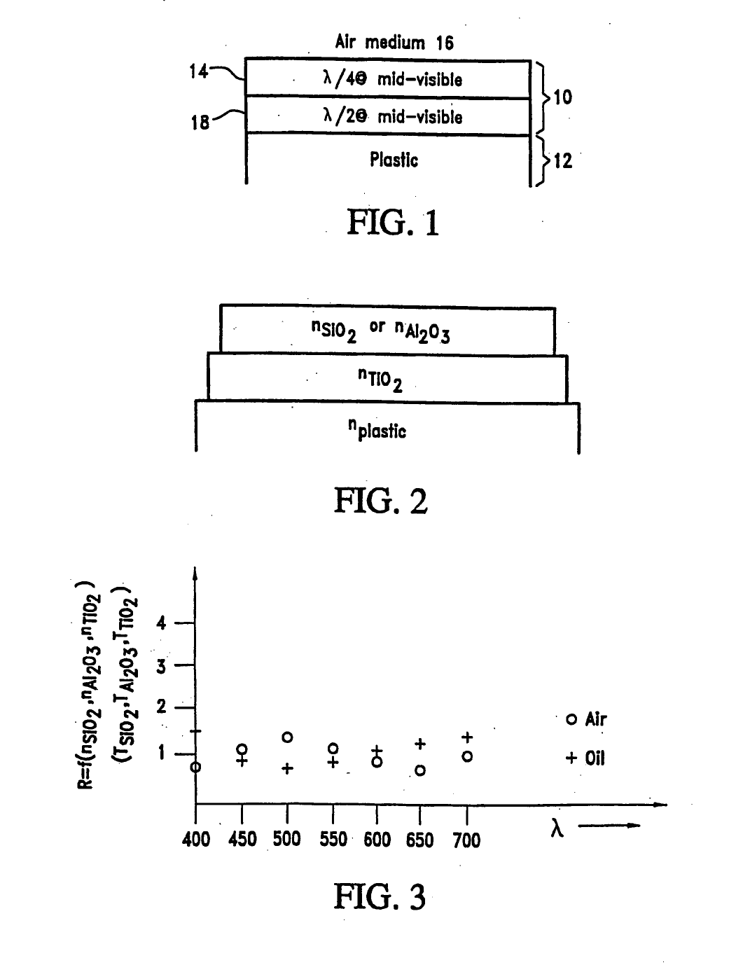

Referring to FIG. 1, a schematic cross-sectional view of the anti-reflection coating of the present invention is illustrated, designated generally as 10. The anti-reflection coating 10 is applied to the surface of a plastic substrate 12 to provide a resultant anti-reflective structure. Coating 10 comprises an upper thin film layer 14 exposed to the ambient environment 16, e.g. air medium, and a lower thin film layer 18 that interfaces with the plastic substrate 12.

As noted above, the upper layer 14 is a material having an optical path length equal to a quarter wave at a pre-selected design wavelength in the range of about 450-550 nanometers, preferably about 500 nanometers. It is preferably Al₂O₃ or SiO₂. The lower layer 18 comprises a material with an index of refraction greater than the index of refraction of the upper layer by at least 0.5, such as TiO₂. TiO₂ has an index of refraction of 2.7 at 500 nanometers. The lower layer has an optical path length equal to a half wave at a pre-selected design wavelength in the range of 450-550 nanometers.

Both the upper and lower layers can be formed by ion beam deposition. Such ion beam deposition can be performed at ambient temperatures obviating, for example, the substrate cycling at high temperatures required by the '876 patent mentioned above. Thus, the present coating can be applied on plastic substrates.

Referring to FIG. 2, a schematic cross-sectional view is illustrated, showing the material layers with their differing indices of refraction. It is the optical response of these materials, as represented by the index of refraction that produces the anti-reflective behavior of the present invention. According to various embodiments the index of refraction of the upper layer is lower than the index of refraction of the lower layer.

Referring now to FIG. 3, reflectance graphs for oil and water are illustrated for the visible range of the spectrum from 400 nanometers. The reflectivity, R, is illustrated as a function of wavelength, λ. The expression for R is a non-analytical solution f(n_{SiO}_{₂},n_{Al}_{₂}_{^{O}}₃,n_{TiO}_{₂},T_{SiO}_{₂},T_{Al}_{₂}_{^{O}}₃, T_{TiO}_{₂}), where n and T are the index of refraction and film thickness, respectively, of the subscripted materials. As can be seen in FIG. 3, the differences between the reflectivity of the various substances indicated for air and for oil are very low. This results in there being no visible fingerprint images in the visible spectrum. Therefore, the fingerprints and other oil-based marks on the substrate will not appear to the human eye.

Obviously, many modifications and variations of the present invention are possible in light of the above teachings. It is, therefore, to be understood that within the scope of the appended claims, the invention may be practiced otherwise than as specifically described.

What is claimed is:

1. A method of forming a fingerprint-resistant anti-reflection coating for application onto a plastic substrate, comprising the steps of:
a) ion beam depositing a lower thin layer onto a plastic substrate, said lower layer having an optical path length equal to a half wave at a pre-selected design wavelength in the range of about 450 to 500 nanometers; and
b) ion beam depositing an upper thin film layer onto said lower thin film layer, an upper surface of said upper thin film layer to be exposed to an ambient environment, said lower layer having an indeix of refraction greater than an index of refraction of said upper layer, said index of refraction of the lower layer being at least 0.5 higher than the index of refraction of the upper layer, said upper layer having an optical path length equal to a quarter wave at a preselected design wavelength in the range of about 450 to 550 nanometers.

2. The method of claim 1, wherein said step of depositing an upper layer comprises depositing an upper layer comprising SiO₂.

3. The method of claim 1, wherein said step of depositing an upper layer comprises depositing an upper layer comprising Al₂O₃.

4. The method of claim 1, wherein said step of depositing a lower layer comprises depositing a lower layer comprising TiO₂.

5. The method of claim 1, wherein said pre-selected design wavelength is 500 nanometers.

6. The method of claim 1, wherein the index of refraction for the plastic substrate is 1.52 and the index of refraction for the lower layer is 2.7.

7. The method of claim 1, wherein the index of refraction of the ambient environment is 1.0 and the index of refraction of said upper layer is 1.5.

8. The method of claim 1, wherein said upper layer is SiO₂, the lower layer is TiO₂ and the design wavelength is 500 nanometers.

9. The method of claim 1, wherein said upper layer is Al₂O₃, the lower layer is TiO₂ and the design wavelength is 500 nanometers.

10. A method of forming a fingerprint-resistant anti-reflection coating for plastic eyeglass lenses, comprising:
selecting a design wavelength;
ion depositing an upper thin film layer to be exposed to an ambient environment, said upper layer having an optical path length substantially equal to about a quarter wave at the selected design wavelength; and
ion depositing a lower thin film layer to interface the plastic eyeglass lenses, said lower layer having an index of refraction greater than an index of refraction of the upper layer, said index of refraction of the lower layer being at least about 0.5 higher than the index of refraction of the upper layer, said lower layer having an optical path length equal to a half wave at the selected design wavelength;
wherein the reflectance of light from said fingerprint-resistant anti-reflection coating when applied to plastic eyeglass lenses is substantially the same in oil and the ambient environment.

11. The method of claim 10, wherein ion depositing the upper layer includes depositing SiO₂.

12. The method of claim 10, wherein ion depositing the upper layer comprises depositing Al₂O₃.

13. The method of claim 10, wherein ion depositing the upper layer comprises depositing TiO₂.

14. The method of claim 10, wherein selecting the design wavelength includes selecting a wavelength of about 450 to about 550 nanometers.

15. A method of forming a fingerprint-resistant anti-reflection structure, comprising:
a) selecting a polymer substrate;
b) ion depositing a lower thin film layer to interface the selected polymer substrate, the lower layer having an index of refraction greater than an index of refraction of the upper layer, the index of refraction of the lower layer being at least 0.5 higher than the index of refraction of the upper layer, the lower layer having an optical path length equal to about a half wave at the pre-selected design wavelength of about 450 to about 550 nanometers; and
c) ion depositing an upper thin film layer, to be exposed to an ambient environment, having an optical path length equal to about a quarter wave at a pre-selected design wavelength of about 450 to about 550 nanometers.

16. The method of claim 15, wherein ion depositing the upper layer includes depositing at least one of SiO₂, Al₂O₃, and combinations thereof.

17. The method of claim 15, wherein ion depositing the lower layer includes depositing TiO₂.

18. The method of claim 15, wherein the pre-selected design wavelength is about 500 nanometers.

19. The method of claim 15, wherein the index of refraction for the plastic substrate is about 1.52 and the index of refraction for the lower layer is about 2.7.

20. The method of claim 15, wherein the index of refraction of the ambient environment is about 1.0 and the index of refraction of the upper layer is about 1.5.

21. The method of claim 15, wherein ion depositing the upper layer includes depositing SiO₂, ion depositing the lower layer includes depositing TiO₂, and the preselected design wavelength is about 500 nanometers.

22. The method of claim 15, wherein ion depositing the upper layer includes depositing Al₂O₃, ion depositing the lower layer includes depositing TiO₂, and the preselected design wavelength is about 500 nanometers.
